(19) United States
(12) Patent Application Publication
(10) Pub. No.: US 2003/0053772 A1
(43) Pub. Date: Mar. 20, 2003

(54) Optical fiber sheet, method of manufacturing the same, and optical fiber interconnector

(75) Inventors: Shogo Ikunishi, Hyogo (JP); Katsuaki Kondo, Hyogo (JP)

Correspondence Address: NIXON PEABODY, LLP, 8180 GREENSBORO DRIVE, SUITE 800, MCLEAN, VA, 22102, US

(73) Assignee: MITSUBISHI CABLE INDUSTRIES, LTD., Amagasaki-shi (JP)

(21) Appl. No.: 10/245,348

(22) Filed: Sep. 18, 2002

(30) Foreign Application Priority Data
Sep. 18, 2001 (JP) 2001-282468

(51) Int. Cl. G02B 6/36

(52) U.S. Cl. 385/114

(57) ABSTRACT

An optical fiber sheet is provided with a plurality of input ports, each constituted by an optical fiber group, a plurality of output ports, each constituted by an optical fiber group made of optical fibers selected from a plurality of optical fibers extending from the plurality of input ports, and a sheet substrate on which the plurality of optical fibers extending from the plurality of input ports to the plurality of output ports is arranged. The plurality of optical fibers includes an optical fiber provided with an identification means that allows identification of the input port side portion and the output port side portion by visual confirmation.

### BACKGROUND OF THE INVENTION

The present invention relates to optical fiber sheets, a method of manufacturing the same, and optical fiber interconnectors, and more particularly relates to optical fibers provided such that combination conversion is performed between a plurality of input ports and a plurality of output ports.

Optical fiber sheets, in which a plurality of optical fibers are provided on a sheet substrate with an adhesive layer and a predetermined number of optical fibers are drawn out from the end portions of the substrate as input ports and output ports with connectors attached to these drawn-out ends, continue to be used as the signal transmission route of communications devices and computers. In general, the optical fibers used in optical fiber sheets are color coded in advance (the coating layer around the optical fiber is colored).

Except for optical fiber sheets that are made of a single optical fiber where the input and the output ports are provided in a single line, when the above mentioned optical fiber sheets have a plurality of input ports or a plurality of output ports, the ports must be identified when the sheet is put into use, for example. In light of this, when each of the plurality of ports is constituted by a single optical fiber, a different colored optical fiber can be adopted for each port so as to make identification of the ports easy. The same also applies if the optical fiber sheets have a single input port constituted by an optical fiber group and a plurality of output ports that branch out therefrom.

However, it is difficult to distinguish the ports when the optical fiber sheet has a plurality of both input and output ports and each of the ports is constituted by an optical fiber group that is made of a plurality of optical fibers and the optical fibers are provided so that they are matrix converted between the input and the output ports. For example, as shown in FIG. 4, when four input ports IN-1 to IN-4 are respectively configured by optical fiber groups 1 to 4, each of which is constituted by four optical fibers, if the optical fibers of the optical fiber group 1 have a red colored layer, the optical fibers of the optical fiber group 2 have a yellow colored layer, the optical fibers of the optical fiber group 3 have an orange colored layer, and the optical fibers of the optical fiber group 4 have a green colored layer, then each port can be identified on the input port side. However, the one red optical fiber of the input port IN-1, as well as one yellow, orange, and green optical fiber from the input ports IN-2 to IN-4 are interconnected to the output port OUT-1, and a similar interconnection arrangement is also adopted at the other output ports OUT-2 to OUT-4. That is, the result is that by arranging the optical fibers so that they are matrix converted, the different colored optical fibers become jumbled at the output ports OUT-1 to OUT-4, and it is substantially impossible to distinguish the output ports from one another, which is inconvenient.

### SUMMARY OF THE INVENTION

It is an object of the present invention to provide an optical fiber sheet, where the ports can be distinguished from one another by identifying which of a plurality of input ports and/or a plurality of output ports at least one optical fiber belongs, a method of manufacturing the same, and a similar optical fiber interconnector.

An optical fiber sheet of the present invention is provided with:

a plurality of input ports, each constituted by an optical fiber group;

a plurality of output ports, each constituted by an optical fiber group made of optical fibers selected from a plurality of optical fibers extending from the plurality of input ports; and

a sheet substrate on which the plurality of optical fibers extending from the plurality of input ports to the plurality of output ports is arranged;

and the plurality of optical fibers includes an optical fiber provided with an identification means that allows identification of the input port side portion and the output port side portion of the optical fiber by visual confirmation.

Here, there are no particular limitations with regard to the “identification means,” and it can for example be a coloring or a marking.

In this optical fiber sheet of the present invention, the optical fibers can be arranged so that they are combination converted between the plurality of input ports and the plurality of output ports, and

the appearance of at least one optical fiber included in the optical fiber groups respectively constituting the plurality of input ports can be different at each port, and the appearance of at least one optical fiber included in the optical fiber groups respectively constituting the plurality of output ports can be different at each port.

Here, “combination conversion” refers to a state where a plurality of optical fibers of at least one input port are provided branching to a plurality of output ports, and/or a state where optical fibers from a plurality of input ports are provided to at least one output port.

An optical fiber sheet of the present invention is provided with:

a plurality of input ports, each constituted by an optical fiber group;

a plurality of output ports, each constituted by an optical fiber group made of optical fibers selected from a plurality of optical fibers extending from the plurality of input ports; and

a sheet substrate on which the plurality of optical fibers extending from the plurality of input ports to the plurality of output ports is arranged;

and the plurality of optical fibers includes an optical fiber allows color of the input port side portion and the output port side portion by visual confirmation.

In this optical fiber sheet of the present invention, the optical fibers can be arranged so that they are combination converted between the plurality of input ports and the plurality of output ports, and

the color of at least one optical fiber included in the optical fiber groups respectively constituting the plurality of input ports can be different at each port, and the color of at least one optical fiber included in the optical fiber groups respectively constituting the plurality of output ports can be different at each port.

Also, in this optical fiber sheet according of the present invention, multi-core optical connectors can be attached to the plurality of input ports and the plurality of output ports.

An optical fiber sheet of the present invention is provided with:

a plurality of input ports, each constituted by an optical fiber group;

a plurality of output ports, each constituted by an optical fiber group made of optical fibers selected from a plurality of optical fibers extending from the plurality of input ports; and

a sheet substrate on which the plurality of optical fibers extending from the plurality of input ports to the plurality of output ports is arranged;

and the plurality of optical fibers includes an optical fiber that has a colored layer that is different in color at the input port side portion and the output port side portion of the optical fiber.

In this optical fiber sheet of the present invention, it is possible that the point where the colored layer of the optical fiber that has a colored layer that is different in color at its input port side portion and its output port side portion is changed in color is located on the sheet substrate.

In this optical fiber sheet of the present invention, it is possible that the optical fibers are arranged so that they are combination converted between the plurality of input ports and the plurality of output ports, and

that the color of the colored layer of at least one optical fiber included in the optical fiber groups respectively constituting the plurality of input ports is different at each port, and the color of the colored layer of at least one optical fiber included in the optical fiber groups respectively constituting the plurality of output ports is different at each port.

In this optical fiber sheet of the present invention, it is also possible that multi-core optical connectors are attached to the plurality of input ports and the plurality of output ports.

In this optical fiber sheet of the present invention, it is also possible that the colored layer of the optical fibers is provided when the optical fibers are arranged on the sheet substrate.

In other words, a method of manufacturing an optical fiber sheet, provided with:

a plurality of input ports, each constituted by an optical fiber group;

a plurality of output ports, each constituted by an optical fiber group made of optical fibers selected from a plurality of optical fibers extending from the plurality of input ports; and

a sheet substrate on which the plurality of optical fibers extending from the plurality of input ports to the plurality of output ports is arranged; and

wherein the plurality of optical fibers includes an optical fiber that has a colored layer that is different in color at its input port side portion and its output port side portion;

where the colored layer of the optical fibers is provided when the optical fibers are arranged on the sheet substrate.

An optical fiber interconnector of the present invention is provided with:

a plurality of input ports, each constituted by an optical fiber group; and

a plurality of output ports, each constituted by an optical fiber group made of optical fibers selected from a plurality of optical fibers extending from the plurality of input ports;

and the plurality of optical fibers includes an optical fiber that is provided with an identification means that allows identification of the input port side portion and the output port side portion of the optical fiber by visual confirmation.

In this optical fiber interconnector of the present invention, the optical fibers can be arranged so that they are combination converted between the plurality of input ports and the plurality of output ports, and

the appearance of at least one optical fiber included in the optical fiber groups respectively constituting the plurality of input ports can be different at each port, and the appearance of at least one optical fiber included can be the optical fiber groups respectively constituting the plurality of output ports is different at each port.

An optical fiber interconnector of the present invention is provided with:

a plurality of input ports, each constituted by an optical fiber group; and

a plurality of output ports, each constituted by an optical fiber group made of optical fibers selected from a plurality of optical fibers extending from the plurality of input ports;

and the plurality of optical fibers includes an optical fiber that has been given coloring that can be identified by visually confirming the input port side portion and the output port side portion of the optical fiber.

In this optical fiber interconnector of the present invention, the optical fibers can be arranged so that they are combination converted between the plurality of input ports and the plurality of output ports, and

the color of at least one optical fiber included in the optical fiber groups respectively constituting the plurality of input ports can be different at each port, and the color of at least one optical fiber included in the optical fiber groups respectively constituting the plurality of output ports can be different at each port.

In this optical fiber interconnector of the present invention, it is also possible that multi-core optical connectors are attached to the plurality of input ports and the plurality of output ports.

An optical fiber interconnector of the present invention is provided with:

a plurality of input ports, each constituted by an optical fiber group; and

a plurality of output ports, each constituted by an optical fiber group made of optical fibers selected from a plurality of optical fibers extending from the plurality of input ports;

and the plurality of optical fibers includes an optical fiber that has a colored layer that is different in color at the input port side portion and the output port side portion of the optical fiber.

In this optical fiber interconnector of the present invention, the optical fibers can be arranged so that they are combination converted between the plurality of input ports and the plurality of output ports, and

the color of the colored layer of at least one optical fiber included in the optical fiber groups respectively constituting the plurality of input ports can be different at each port, and the color of the colored layer of at least one optical fiber included in the optical fiber groups respectively constituting the plurality of output ports can be different at each port.

In this optical fiber interconnector of the present invention, it is also possible that multi-core optical connectors are attached to the plurality of input ports and the plurality of output ports.

According to each of the configurations of the present invention as set forth above, with regard to at least the optical fiber provided with an identification means, the ports can be identified because it is possible to distinguish to which of the plurality of input ports and/or the plurality of output ports the optical fiber belongs. In particular, even if the optical fibers are combination converted such as matrix converted between the plurality of input ports and the plurality of output ports, each of which is constituted by an optical fiber group, by providing an identical identification means to all optical fibers belonging to an identical port, the input ports and the output ports can be clearly distinguished on not only the input port side but also on the output port side.

### BRIEF DESCRIPTION OF THE DRAWINGS

FIG. 1 is a plan view of an optical fiber sheet according to Embodiment 1 of the present invention.

FIG. 2 is a magnified plan view of the portion denoted by A in FIG. 1.

FIG. 3 is a plan view of an optical fiber sheet according to Embodiment 2 of the present invention.

FIG. 4 is a plan view of a conventional optical fiber sheet.

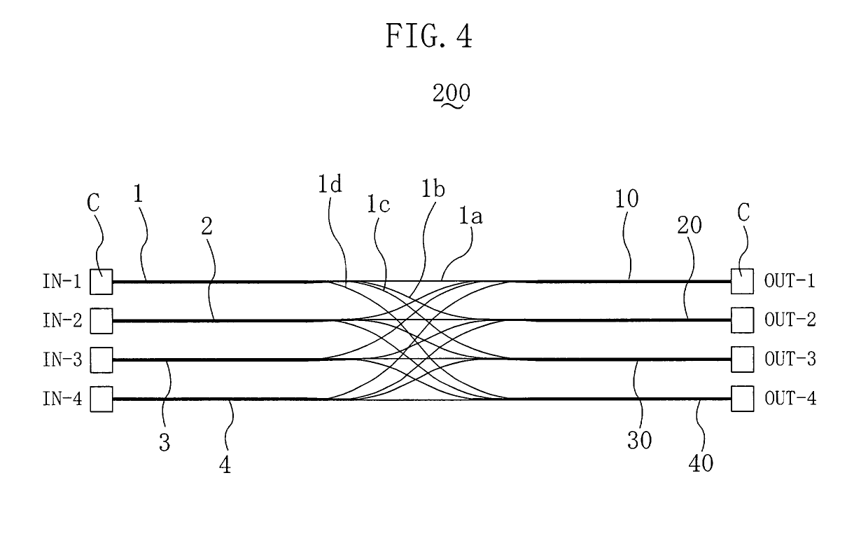

### DETAILED DESCRIPTION OF THE INVENTION

Embodiments of the present invention are described in detail with reference to the drawings.

Embodiment 1

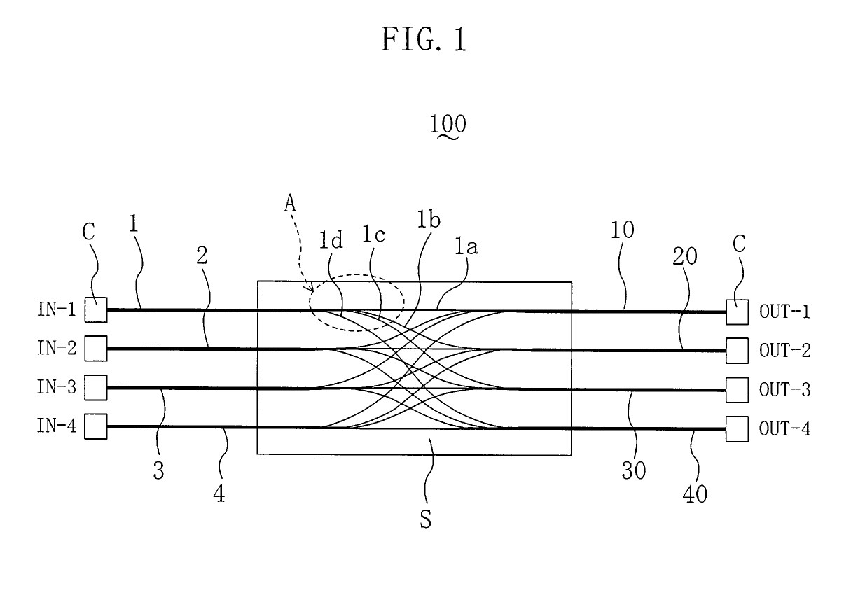

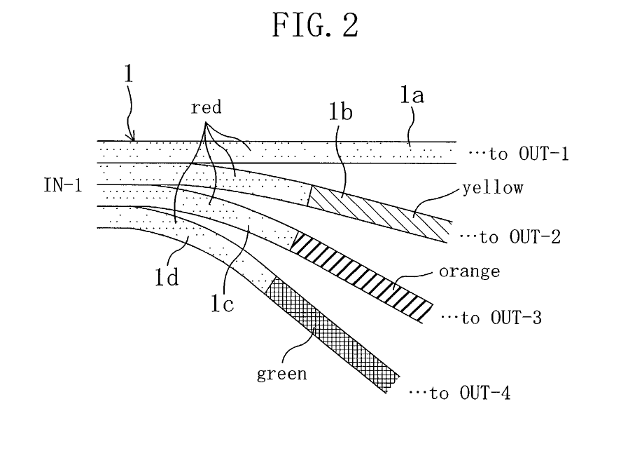

FIG. 1 shows an optical fiber sheet 100 according to Embodiment 1 of the present invention. FIG. 2 is a magnified view of the portion denoted by A in FIG. 1.

The optical fiber sheet 100 is provided with four input ports IN-1 to IN-4, which are respectively constituted by optical fiber groups 1, 2, 3, and 4, four output ports OUT-1 to OUT-4, which are respectively constituted by optical fiber groups 10, 20, 30, and 40 each made of optical fibers selected from the plurality of optical fibers extending from the four input ports IN-1 to IN-4, a sheet substrate S on which the plurality of optical fibers extending from the input ports IN-1 to IN-4 to the output ports OUT-1 to OUT-4 are arranged, and multi-core optical connectors C attached to the input ports IN-1 to IN-4 and the output ports OUT-1 to OUT-4.

The input port IN-1 is made of the optical fiber group 1, which is constituted by four optical fibers 1a to 1d. The optical fiber 1a is provided leading to the output port OUT-1, the optical fiber 1b is provided leading to the output port OUT-2, the optical fiber Ic is provided leading to the output port OUT-3, and the optical fiber 1d is provided leading to the output port OUT-4. Similarly, one optical fiber each from the optical fiber groups 2 to 4 of the input ports IN-2 to IN-4 respectively leads to the output ports OUT-1 to OUT-4. That is, the optical fibers are arranged on the optical fiber sheet 100 so that they are matrix converted between the input ports IN-1 to IN-4 and the output ports OUT-1 to OUT-4.

The outermost layer of the optical fibers arranged on the sheet substrate S is provided with a colored layer, and the color of the colored layer is suitably altered midway in the interconnection arrangement from the input ports IN-1 to IN-4 to the output ports OUT-1 to OUT-4. More specifically, the colored layer of each optical fiber of the optical fiber group 1 of the input port IN-1 is red, and the color of the colored layer of the optical fiber 1a thereof that leads to the output port OUT-1 stays red. On the other hand, the colored layer of the optical fiber 1b that leads to the output port OUT-2 is changed midway from red to yellow. Also, the colored layer of the optical fiber 1c that leads to the output port OUT-3 is changed midway from red to orange, and the colored layer of the optical fiber 1d that leads to the output port OUT-4 is changed midway from red to green. Similarly, the colored layer of each optical fiber of the optical fiber group 2 of the input port IN-2 is yellow, the colored layer of each optical fiber of the optical fiber group 3 of the input port IN-3 is orange, and the colored layer of each optical fiber of the optical fiber group 4 of the input port IN-4 is green, and the color of the colored layer of each optical fiber is changed appropriately so that the colored layers of the optical fibers leading to the output port OUT-1 are red, the colored layers of the optical fibers leading to the output port OUT-2 are yellow, the colored layers of the optical fibers leading to the output port OUT-3 are orange, and the colored layers of the optical fibers leading to the output port OUT-4 are green. That is, by providing a color separation scheme (identification means) so that the colored layer on the portion of the optical fibers on the input port side and on the output port side can be visually identified, all of the optical fibers in each of the optical fiber groups 1, 2, 3, and 4 of the input ports IN-1 to IN-4 have the same color and all of the optical fibers of each of the optical fiber groups 10, 20, 30, and 40 of the output ports OUT-1, to OUT-4 have the same color.

Consequently, with the optical fiber sheet 100, the colored layers of the four optical fibers of the optical fiber group 1 of the input port IN-1 are red, the colored layers of all the optical fibers of the optical fiber group 2 of the input port IN-2 are yellow, the colored layers of all the optical fibers of the optical fiber group 3 of the input port IN-3 are orange, and the colored layers of all the optical fibers of the optical fiber group 4 in the input port IN-4 are green, so that at each port the colored layers have a different color. Moreover, the colored layers of the four optical fibers of the optical fiber group 10 of the output port OUT-1 are red, the colored layers of all the optical fibers of the optical fiber group 20 of the output port OUT-2 are yellow, the colored layers of all the optical fibers of the optical fiber group 30 of the output port OUT-3 are orange, and the colored layers of all the optical fibers of the optical fiber group 40 of the output port OUT-4 are green, so that the colored layers have a different color at each port. Therefore, regardless of the fact that the optical fibers are arranged so that they are combination converted, the ports can be clearly identified not only on the input port side but on the output port side as well.

It is preferable that a sheet material that is provided with an adhesive layer capable of adhering and fastening the arranged optical fibers is employed as the sheet substrate S used in the invention. For example, a resin sheet made of polyimide resin, polyethylene terephthalate resin, or polyethylene naphthalate resin or the like can be suitably adopted as the sheet material. Also, the adhesive layer should be viscous and adhesive and reliably fix the optical fiber, and for example can be a silicon-based adhesive agent. It should be noted that a protective sheet is ordinarily placed over the optical fibers after they have been arranged on the sheet substrate S in order to prevent interconnection mix-ups and protect against external damage. The aforementioned resin sheet can also be adopted as this protective sheet.

The optical fibers can be arranged on the sheet substrate S by a method employing an interconnection device that is provided with an optical fiber supply means, such as a reel on which optical fiber has been wound, and a rotatable interconnection head, and optical fiber is drawn out from the head and adhered to the adhesive layer of the sheet substrate S while a predetermined pattern is drawn so that the optical fibers are provided in a straight line via a route stretching outward from the edge of the sheet substrate S, and then the optical fibers protruding from the substrate are severed.

In this embodiment, the plurality of optical fibers provided on the sheet substrate S must include optical fibers that have been color coded so that different colors can be visually confirmed on the input port side portion and the output port side portion of the optical fibers. This color-coding is provided as a colored coating around the entire circumference of the outermost layer of the optical fiber and serves as the colored layer. In addition to providing different colors at the input port and the output port side portions, it is also possible to have non-colored layers or, when the color of the underlying layer is identical to the color of the colored layer, to attach line markers or dotted marks, for example, that are different colors at the input port side portion and the output port side portion of optical fiber.

Moreover, as long as the color coding is visually recognizable at least at the input port side portion and the output port side portion, it does not necessarily have to be given over the entire length of the optical fibers. For example, the above-mentioned line markers or the like can be provided at a single portion of the optical fibers extending from each port.

The line markers or the like do not have to be provided on every optical fiber when there are a plurality of optical fibers extending from each port, and may be provided on at least one of the optical fibers of each port.

As described hereinabove, various different methods can be adopted for color coding the optical fibers so that they are colored differently at their input port and output port side portions, however, from the standpoint of manufacturing efficiency and the appearance of the finished product, for example, it is preferable that the point where the colored layers change in color is located on the sheet substrate. The point where the color is changed can be formed by adding a mechanism to the above-mentioned interconnection device that gives color to the optical fibers. That is, in the case of Embodiment 1, the optical fibers can conceivably be colored immediately before they are interconnected to the sheet substrate S by, for example, disposing a coloring head impregnated with red, yellow, orange, and green colored ink and adding a retractable mechanism that can come into contact with the optical fiber that is supplied and reeled forward by the interconnection head, or by disposing an inkjet head that is able to eject ink with respect to the optical fibers.

The optical fibers can be colored while they are provided in a single line by calculating the point at which the color should change on the sheet substrate from the amount of optical fiber that is drawn out, for example, and activating the appropriate color of the above-mentioned coloring head or inkjet head. It should be noted that it is sufficient for the optical fibers to be identified at the portions where they protrude from the substrate at the input and the output ports, that is, it is sufficient for the color change to occur at any point on the sheet substrate, and therefore dimensional precision is not necessarily required with regard to the change in color.

Multi-core optical connectors C are attached to the ends of the input ports IN-1 to IN-4 and the output ports OUT-1 to OUT-4. Ordinarily, multi-core optical connectors C are connected after the optical fibers have been arranged on the sheet substrate S, waveguide tests and the like have been performed, and unwanted optical fibers have been removed, but with the optical fiber sheet 100 of this embodiment, the optical fibers of the input ports IN-1 to IN-4 and the output ports OUT-1 to OUT-4 are clearly separated by color, and thus mistakes do not occur during the task of attaching the multi-core optical connectors C. Consequently, the task of attaching the multi-core optical connectors C is very efficient, so that the productivity of the optical fiber sheet 100 is increased.

Embodiment 2

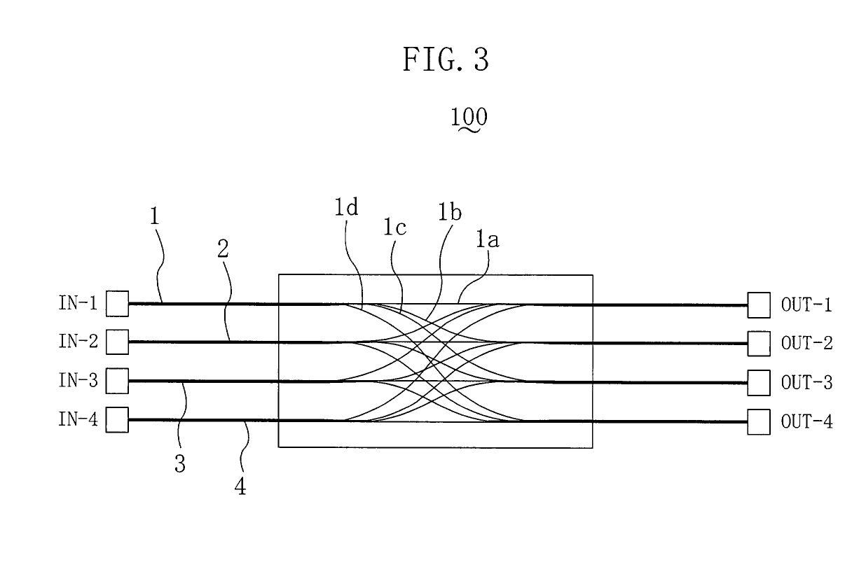

FIG. 3 shows an optical fiber interconnector 200 according to Embodiment 2 of the present invention. Portions thereof identical to Embodiment 1 are indicated by identical reference numerals.

The structure of the optical fiber interconnector 200 is that of the optical fiber sheet 100 according to Embodiment 1 without the sheet substrate. Consequently, the optical fiber interconnector 200 is provided with four input ports IN-1 to IN-4 and four output ports OUT-1 to OUT-4, with multi-core optical connectors C attached to each port, and the optical fibers have been arranged so that they are matrix converted from the input ports IN-1 to IN-4 toward the output ports OUT-1 to OUT-4. More specifically, the input port IN-1 is configured by the optical fiber group 1, which is made of four optical fibers 1a to 1d, of which a single optical fiber 1a leads to the output port OUT-1, a single optical fiber 1b leads to the output port OUT-2, a single optical fiber 1c leads to the output port OUT-3, and a single optical fiber 1d leads to the output port OUT-4. Similarly, single optical fibers of each of the optical fiber groups 2 to 4 of the input ports IN-2 to IN-4 lead to the output ports OUT-1 to OUT-4. That is, the optical fibers are arranged in the optical fiber interconnector 200 so that they are matrix converted between the input ports IN-1 to IN-4 and the output ports OUT-1 to OUT-4.

A colored layer is provided as the outermost layer of the each of the optical fibers, and the color of the colored layers is suitably altered midway through the interconnection arrangement. More specifically, the colored layer of each optical fiber of the optical fiber group 1 of the input port IN-1 is red, and the color of the colored layer of the optical fiber 1a thereof that leads to the output port OUT-1 stays red. On the other hand, the colored layer of the optical fiber 1b that leads to the output port OUT-2 is changed midway from red to yellow. Also, the colored layer of the optical fiber 1c that leads to the output port OUT-3 is changed midway from red to orange, and the colored layer of the optical fiber 1d that leads to the output port OUT-4 is changed midway from red to green. Similarly, the colored layer of each optical fiber of the optical fiber group 2 of the input port IN-2 is yellow, the colored layer of each optical fiber of the optical fiber group 3 of the input port IN-3 is orange, and the colored layer of each optical fiber of the optical fiber group 4 of the input port IN-4 is green, and the color of the colored layer of each optical fiber is changed appropriately so that the colored layers of the optical fibers leading to the output port OUT-1 are red, the colored layers of the optical fibers leading to the output port OUT-2 are yellow, the colored layers of the optical fibers leading to the output port OUT-3 are orange, and the colored layers of the optical fibers leading to the output port OUT-4 are green. That is, by providing a color separation scheme (identification means) so that the colored layer on the portion of the optical fibers at the input port side and the output port side can be visually identified, all of the optical fibers in each of the optical fiber groups 1, 2, 3, and 4 of the input ports IN-1 to IN-4 have the same color and all of the optical fibers of in each of the optical fiber groups 10, 20, 30, and 40 of the output ports OUT-1, to OUT-4 are the same color.

Consequently, with the optical fiber interconnector 200, the four optical fibers of the optical fiber group 1 of the input port IN-1 are red, all the optical fibers of the optical fiber group 2 of the input port IN-2 are yellow, all the optical fibers of the optical fiber group 3 of the input port IN-3 are orange, and all the optical fibers of the optical fiber group 4 in the input port IN-4 are green, so that at each port the colored layers have a different color. Moreover, the four optical fibers of the optical fiber group 10 of the output port OUT-1 are red, all the optical fibers of the optical fiber group 20 of the output port OUT-2 are yellow, all the optical fibers of the optical fiber group 30 of the output port OUT-3 are orange, and all the optical fibers of the optical fiber group 40 of the output port OUT-4 are green, so that the colored layers have a different color at each port. Therefore, regardless of the fact that the optical fibers are arranged in matrix conversion, the ports can be clearly identified not only on the input port side but on the output port side as well.

The optical fiber interconnector 200 can be easily produced by arranging optical fibers on a sheet substrate to create the optical fiber sheet 100 according to Embodiment 1, turning the optical fiber groups 1 to 4 and 10 to 40, which constitute the input ports IN-1 to IN-4 and the output ports OUT-1 to OUT-4, respectively, into a tape-shape (securely adhering them), and then removing the sheet substrate. The optical fiber interconnector 200 can also be produced by arranging optical fibers on a sheet substrate to create the optical fiber sheet 100 according to Embodiment 1, attaching multi-core optical connectors C to the input ports IN-1 to IN-4 and the output ports OUT-1 to OUT-4, and then removing the sheet substrate.

The look of the coloring, the method of coloring the optical fibers, and the operational effects are the same as in Embodiment 1.

Other Embodiments

Hereinabove, Embodiments 1 and 2 were described with regard to an interconnection arrangement for achieving matrix conversion, however, the present invention can also be variously adopted to a variety of other interconnection patterns, including other combination conversion arrangements where identification of the ports is necessary. Also, with regard to the color change, it is not absolutely necessary that all optical fibers are changed in color so that each input port and output port has identically colored optical fibers, and only required is the color change to clearly distinguish the ports from one another. For example, the ports can be distinguished by the color change of only one optical fiber included in the optical fiber group.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical fiber sheet comprising:
a plurality of input ports, each constituted by an optical fiber group;
a plurality of output ports, each constituted by an optical fiber group made of optical fibers selected from a plurality of optical fibers extending from the plurality of input ports; and
a sheet substrate on which the plurality of optical fibers extending from the plurality of input ports to the plurality of output ports is arranged;
wherein the plurality of optical fibers includes an optical fiber provided with an identification means that allows identification of the input port side portion and the output port side portion by visual confirmation.

2. The optical fiber sheet according to claim 1, wherein the optical fibers are arranged so that they are combination converted between the plurality of input ports and the plurality of output ports, and
wherein the appearance of at least one optical fiber included in the optical fiber groups respectively constituting the plurality of input ports is different at each port, and the appearance of at least one optical fiber included in the optical fiber groups respectively constituting the plurality of output ports is different at each port.

3. An optical fiber sheet comprising:
a plurality of input ports, each constituted by an optical fiber group;
a plurality of output ports, each constituted by an optical fiber group made of optical fibers selected from a plurality of optical fibers extending from the plurality of input ports; and
a sheet substrate on which the plurality of optical fibers extending from the plurality of input ports to the plurality of output ports is arranged;
wherein the plurality of optical fibers includes an optical fiber that allows color identification of the input port side portion and the output port side portion by visual confirmation.

4. The optical fiber sheet according to claim 3, wherein the optical fibers are arranged so that they are combination converted between the plurality of input ports and the plurality of output ports, and
wherein the color of at least one optical fiber included in the optical fiber groups respectively constituting the plurality of input ports is different at each port, and the color of at least one optical fiber included in the optical fiber groups respectively constituting the plurality of output ports is different at each port.

5. The optical fiber sheet according to claim 3, wherein multi-core optical connectors are attached to the plurality of input ports and the plurality of output ports.

6. An optical fiber sheet comprising:
a plurality of input ports, each constituted by an optical fiber group;
a plurality of output ports, each constituted by an optical fiber group made of optical fibers selected from a plurality of optical fibers extending from the plurality of input ports; and
a sheet substrate on which the plurality of optical fibers extending from the plurality of input ports to the plurality of output ports is arranged;
wherein the plurality of optical fibers includes an optical fiber that has a colored layer that is different in color at the input port side portion and the output port side portion of the optical fiber.

7. The optical fiber sheet according to claim 6, wherein the point where the colored layer of the optical fiber that has a colored layer that is different in color at its input port side portion and its output port side portion is changed in color is located on the sheet substrate.

8. The optical fiber sheet according to claim 6, wherein the optical fibers are arranged so that they are combination converted between the plurality of input ports and the plurality of output ports, and
wherein the color of the colored layer of at least one optical fiber included in the optical fiber groups respectively constituting the plurality of input ports is different at each port, and the color of the colored layer of at least one optical fiber included in the optical fiber groups respectively constituting the plurality of output ports is different at each port.

9. The optical fiber sheet according to claim 6, wherein the colored layer of the optical fibers is provided when the optical fibers are arranged on the sheet substrate.

10. The optical fiber sheet according to claim 6, wherein multi-core optical connectors are attached to the plurality of input ports and the plurality of output ports.

11. A method of manufacturing an optical fiber sheet that comprises:
a plurality of input ports, each constituted by an optical fiber group;
a plurality of output ports, each constituted by an optical fiber group made of optical fibers selected from a plurality of optical fibers extending from the plurality of input ports; and
a sheet substrate on which the plurality of optical fibers extending from the plurality of input ports to the plurality of output ports is arranged; and
wherein the plurality of optical fibers includes an optical fiber that has a colored layer that is different in color at its input port side portion and its output port side portion;
the method comprising providing the colored layer of the optical fibers when the optical fibers are arranged on the sheet substrate.

12. An optical fiber interconnector comprising:
a plurality of input ports, each constituted by an optical fiber group; and
a plurality of output ports, each constituted by an optical fiber group made of optical fibers selected from a plurality of optical fibers extending from the plurality of input ports;
wherein the plurality of optical fibers includes an optical fiber that is provided with an identification means that allows identification of the input port side portion and the output port side portion by visual confirmation.

13. The optical fiber interconnector according to claim 12, wherein the optical fibers are arranged so that they are combination converted between the plurality of input ports and the plurality of output ports, and
wherein the appearance of at least one optical fiber included in the optical fiber groups respectively constituting the plurality of input ports is different at each port, and the appearance of at least one optical fiber included in the optical fiber groups respectively constituting the plurality of output ports is different at each port.

14. An optical fiber interconnector comprising:
a plurality of input ports, each constituted by an optical fiber group; and
a plurality of output ports, each constituted by an optical fiber group made of optical fibers selected from a plurality of optical fibers extending from the plurality of input ports;
wherein the plurality of optical fibers includes an optical fiber that has been given coloring that can be identified by visually confirming the input port side portion and the output port side portion of the optical fiber.

15. The optical fiber interconnector according to claim 14, wherein the optical fibers are arranged so that they are combination converted between the plurality of input ports and the plurality of output ports, and
wherein the color of at least one optical fiber included in the optical fiber groups respectively constituting the plurality of input ports is different at each port, and the color of at least one optical fiber included in the optical fiber groups respectively constituting the plurality of output ports is different at each port.

16. The optical fiber interconnector according to claim 14, wherein multi-core optical connectors are attached to the plurality of input ports and the plurality of output ports.

17. An optical fiber interconnector comprising:
a plurality of input ports, each constituted by an optical fiber group; and
a plurality of output ports, each constituted by an optical fiber group made of optical fibers selected from a plurality of optical fibers extending from the plurality of input ports;
wherein the plurality of optical fibers includes an optical fiber that has a colored layer that is different in color at the input port side portion and the output port side portion of the optical fiber.

18. The optical fiber interconnector according to claim 17, wherein the optical fibers are arranged so that they are combination converted between the plurality of input ports and the plurality of output ports, and
wherein the color of the colored layer of at least one optical fiber included in the optical fiber groups respectively constituting the plurality of input ports is different at each port, and the color of the colored layer of at least one optical fiber included in the optical fiber groups respectively constituting the plurality of output ports is different at each port.

19. The optical fiber interconnector according to claim 17, wherein multi-core optical connectors are attached to the plurality of input ports and the plurality of output ports.
